(19) United States
(12) Patent Application Publication
(10) Pub. No.: US 2005/0169339 A1
(43) Pub. Date: Aug. 4, 2005

(54) Monolithic wafer-scale waveguide-laser

(76) Inventor: Michael J. Cumbo, Santa Rosa, CA (US)

Correspondence Address: STALLMAN & POLLOCK LLP, SUITE 2200, 353 SACRAMENTO STREET, SAN FRANCISCO, CA, 94111, US

(21) Appl. No.: 11/044,326

(22) Filed: Jan. 27, 2005

Related U.S. Application Data
(60) Provisional application No. 60/542,112, filed on Feb. 4, 2004.

(51) Int. Cl. H01S 3/06

(52) U.S. Cl. 372/66; 372/67

(57) ABSTRACT

A waveguide laser is formed by starting with a glass disc doped with a rare earth element to define a lasant material. The disc is etched or machined to define an elongated waveguide channel having a spiral configuration. The open area between the walls of the waveguide channel is filled with a cladding material. An end reflector is formed on the radial inner end of the spiral waveguide. First cladding layers are formed on both sides of the spiral waveguide. A second cladding layer is deposited on at least one of the first cladding layers. A heat sink is connected to the second cladding layer. A plurality of optical pump sources are positioned about the side walls of the structure to excite the lasant material and generate a laser beam. In one preferred embodiment, the side walls of the structure are provided with a convex configuration to enhance pump coupling.

### PRIORITY

This application claims priority from provisional application Ser. No. 60/542,112, filed Feb. 4, 2004, the disclosure of which is incorporated herein by reference.

### TECHNICAL FIELD OF THE INVENTION

The present invention relates generally to lasers employed in material processing, optical telecommunications, projection display, and optical fabrication technology. The invention relates in particular to a monolithic wafer-scale waveguide laser.

### DISCUSSION OF BACKGROUND ART

Double clad (DC) optical fiber technology has given rise to a new class of infrared lasers that are more compact, energy efficient, and reliable than solid-state lasers based on rod, slab, and disk laser architectures. DC fiber lasers generally rely on at least one (often many) discrete, near-infrared (NIR) semiconductor diode pump laser to provide excitation energy to a resonant cavity of the laser. The resonant cavity is formed in a rare earth (Nd, Yb, Pr, Er, etc.) ion-doped core region of the DC fiber.

The pump laser output energy is typically fiber coupled and then spliced to an inner cladding of the double clad fiber. The refractive index profile of a DC fiber confines the pump laser energy to the inner cladding and core regions of the fiber. The active ions in the central core region are excited by the pump energy and, by stimulated emission and the waveguiding action of the higher index host core region, radiate laser light along the axis of the DC fiber core. A reflector and an output coupler (often fiber Bragg gratings) form the ends of the fiber laser cavity. A better mode quality (and longer wavelength) energy is emitted from the output coupler than is emitted by the pump lasers. In essence, the DC fiber laser converts relatively poor mode quality, i.e. low brightness, energy from the pump laser to superior mode quality, i.e., higher brightness, radiation. The output radiation wavelength depends upon the detailed spectroscopy of the active ions in the core region, the pump laser wavelength, and the optical path length of the fiber laser cavity.

U.S. Pat. No. 6,052,392, to Ueda et al, discloses a laser including an optical guide with active lasing substance, wherein laser oscillation is provided by supplying excitation light to the active lasing substances. The optical guide is continuous and is relatively long over an area containing the optical guide. It is arranged in a conglomerate form by being repeatedly folded or wound. Excitation light is radiated to the optical guide at its outer periphery. The conglomerate form may be a disc shape, a cone shape, a regular polyhedron shape, a truncated polyhedron shape, an ellipse shape, a cocoon shape, an ellipsoid of revolution shape, a spiral shape, a sphere shape, a donut or ring shape, a torus shape, a fabric shape, a shape linearly converted from one of the aforementioned shapes, or a shape in combination of all or part of those shapes. The optical guide is preferably made of an optical fiber and has at least one optical waveguide. The optical fiber in the conglomerate form is made immobile by covering all or a part of the optical fiber with a setting substance which transmits the excitation light. The setting substance can be selected from a setting organic resin or glass, or a setting inorganic medium. The optical guide is either a double clad type optical fiber or an optical waveguide, formed with a clad, and with a second clad placed outside the clad.

The apparatus of Ueda et al has several disadvantages. It requires careful winding/spooling of at least one discrete segment of ion-doped glass fiber to form a resonant cavity within a cylindrical or circular space. The optical fiber has a relatively small diameter of between about 100 micrometers (μm) and 1,000 μm. Given this relatively small diameter, the optical fiber is exposed to a danger of scratching the fiber cladding during handling. This can make winding and spooling the optical fiber a very tedious operation. Further, the excitation of the active ions in the optical fiber core is achieved by side-pumping the spooled fiber laser cavity with one or more semiconductor diode lasers. This requires the use of discrete lenses (or mirrors) to efficiently couple the pump laser output energy into the fiber laser cavity, thereby adding labor and cost to the manufacturing process. Finally, suppression of damage due to mechanical vibration of the fiber laser cavity and efficient coupling of pump laser energy into the cavity requires “potting” of the fiber in a binding matrix. The binding matrix must be transparent to the pump laser energy, it must fill in the gaps between the windings of the fiber laser cavity to minimize Fresnel reflection and optical scattering losses, and it should not inhibit the conduction of unwanted heat out of the fiber laser cavity. It is difficult (if not impossible) to find a binding matrix that satisfies all of these requirements.

U.S. Pat. No. 4,782,491 to Snitzer, teaches an optical fiber laser comprising a nearly pure fused silica glass, neodymium doped active core within a cavity in the form of a single mode optical fiber. The gain cavity is end pumped at a nominal wavelength of 0.8 μm and its length and neodymium concentration are adjusted to maximize pump absorption and minimize concentration quenching. Dichroic mirrors are preferably integrally formed on ends of the cavity and have reflection characteristics selected so that the laser has an output at a nominal wavelength of 1.06 μm.

U.S. Pat. No. 4,780,877 to Snitzer, depicts an optical fiber laser comprising a gain cavity in the form of a single-mode optical fiber with integrally formed dichroic mirror end sections to provide feedback. The fiber core comprises a host material of silicate glass preferably doped with 0.01 to 1 weight percent of just erbium oxide as a lasing medium. The laser is end pumped at approximately 1.49 μm with a laser diode, preferably indium gallium arsenide phosphide (InGaAsP), and has an output at 1.54 μm.

U.S. Pat. No. 4,680,767 to Hakimi, et al., discloses an optical fiber laser comprising a gain cavity in the form of a single-mode optical fiber with integrally formed reflective end sections for provision of feedback. One end-section is an etalon for modifying the gain cavity resonant characteristics and intensity modulation, and the other end-section is used to alter gain cavity effective length to tune and frequency modulate. The emission spectrum of the laser gain material (which is preferably neodymium oxide incorporated in a silicate glass core), along with the etalon section reflection, pump energy level, and gain cavity length, all cooperate such that lasing takes place over just a single line of narrow width or over more than one line within a narrow band. Electro-optic material in the end sections permit output frequency and amplitude to be selectively activated in response to the application of applied voltages.

U.S. Pat. No. 4,015,217 to Snitzer, teaches laserable material with a host material of non-gaseous, non-periodic atomic structures. The host material is plastic dispersed in solid solution within the plastic and is a chelate of a rate earth metal.

All of the Snitzer designs, as well as the Hakimi design, require the handling of at least one discrete segment of ion-doped glass fiber to form a resonant cavity. Given the small diameter of such optical fiber and the danger of scratching the fiber cladding or fracturing the fiber during handling, as discussed above, this can be a tedious operation. Further, in each of the Snitzer and Hakimi designs, excitation of the active ions is achieved by end-pumping or side-pumping the fiber laser cavity with one or more semiconductor diode lasers. This requires the splicing of additional segments of (undoped) fiber to couple the pump laser output energy into the fiber laser cavity. Accordingly, labor requirements can be high and manufacturing yields can be challenging.

Finally, in the Snitzer and Hakimi designs, suppression of damage due to mechanical vibration of the fiber laser cavity typically requires spooling and “potting” of the fiber in a binding matrix (usually an organic material). The binding matrix should not inhibit the conduction of unwanted heat out of the fiber. It is difficult to find a suitably compliant and robust binding matrix that is also a good thermal conductor. The above cited patents are incorporated herein by reference.

There remain several technical problems in need of resolution. Because the optical conversion efficiency of an ion-doped DC fiber core is less than 100% (typically between 50% and 70%), the remaining pump laser energy must be dissipated as heat along the length of the DC fiber. Some provision must be made to conduct this unwanted heat away from the DC fiber. In a high output power, for example, greater than 100 Watts (W), fiber laser, thermal management is a significant challenge.

The state of the art in semiconductor pump lasers is such that multiple pump lasers must be fiber coupled and then spliced to the DC fiber's inner cladding. In high output power designs, splicing of the fiber-coupled emitter pumps or multiple emitter bars is a major factor in the cost, manufacturing yield, and reliability of the fiber laser.

In order to achieve sufficient optical gain, the fiber laser cavity is typically very long, for example between 1 meter (m) and 100 m, necessitating winding and/or spooling of the double clad fiber to save space. The DC fiber must be handled with care during such winding to avoid scratches or fractures, and it must be protected from mechanical damage (vibration, etc.) during use. Therefore, the DC fiber is usually potted in some kind of binder matrix (often an organic material) after it has been spooled.

### SUMMARY OF THE INVENTION

A waveguide laser is formed by starting with a glass disc doped with a rare earth element to define a laser gain medium material. Using semiconductor type manufacturing techniques, the disc is etched or machined to define an elongated waveguide channel having a spiral configuration. The open area between the walls of the waveguide channel is filled with a material having a lower index of refraction. An end reflector is formed on the radial inner end of the spiral waveguide.

First cladding layers are formed on both sides of the spiral waveguide. The index of refraction of the cladding layers preferably matches the index of refraction of the material located between the waveguide walls. In the preferred embodiment, a pair of second cladding layers are deposited on the first cladding layers. Each second cladding layer has an index of refraction less than the index of refraction of the first cladding layers. At least one heat sink is connected to one of the second cladding layers.

A plurality of optical pump sources are positioned about the side walls of the structure. Preferably, the optical pump sources are semiconductor diode lasers. In one preferred embodiment, the side walls of the structure are provided with a convex configuration to enhance coupling.

In a preferred fabrication method, the glass disc is first bonded to a glass substrate. Then the spiral waveguide is formed by etching or machining. A capping layer is then conformally deposited or flowed over the spiral structure to fill the voids. After planarization, a top substrate is bonded onto the capping layer. The top and bottom substrates can then be ground and polished to define the first cladding layers. The second cladding layers can then be deposited onto the first cladding layers. Finally, the heat sinks can be bonded to the second layers.

Further features of the subject invention will be apparent in view of the following detailed description and drawings.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIGS. 1A and 1B are respectively plan and elevation cross-section views, with FIG. 1B seen generally in the direction 1B-1B of FIG. 1A, and FIG. 1A seen generally in the direction 1A-1A of FIG. 1B, schematically illustrating one preferred embodiment of a monolithic wafer-scale waveguide laser in accordance with the present invention including a spiral waveguide of a laser material immersed in a cladding material in the form of a disk, the periphery of which forms an anamorphic lens.

FIGS. 2A and 2B are respectively plan and elevation cross section views, with FIG. 2B seen generally in the direction 2B-2B of FIG. 2A, and FIG. 2A seen generally in the direction 2A-2A of FIG. 2B, schematically illustrating the laser of FIGS. 1A and 1B, further including a plurality of diode pump lasers disposed around the periphery of the cladding material and delivering pump energy to the spiral waveguide via the lens formed on the periphery of the cladding material.

FIGS. 3A-L are elevation cross-section views schematically illustrating steps in one preferred method for fabricating the monolithic wafer-scale waveguide-laser of FIGS. 1A and 1B.

### DETAILED DESCRIPTION OF THE INVENTION

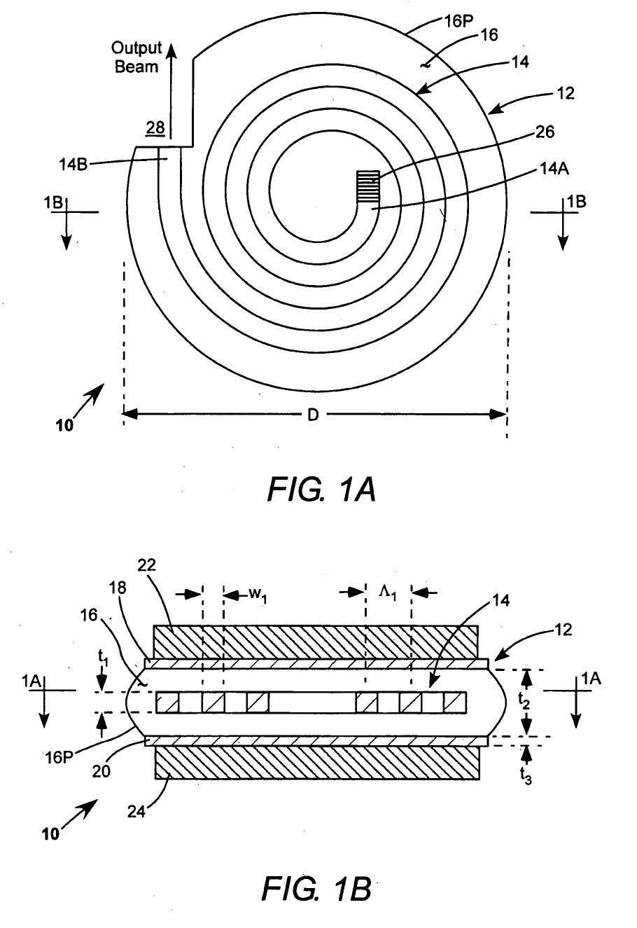

Referring now to the drawings, wherein like features are designated by like reference numerals, FIG. 1A and FIG. 1B schematically illustrate a preferred embodiment 10 of a monolithic, wafer-scale waveguide-laser in accordance with the present invention. Laser 10 includes a wafer body 12, preferably disc-shaped and having a diameter (D). The wafer body includes an ion-doped spiral waveguide 14 preferably having a rectangular cross-section. The waveguide is formed from a material having a refractive index n₁. The rectangular cross-section is characterized by a thickness (height) t₁ and a width w₁. The waveguide spirals are separated center-to-center by a distance Λ₁.

The waveguide layer is immersed in an inner cladding layer 16. Cladding layer 16 is formed from a material having a refractive index n₂, where n₂ is less than n₁. Inner cladding layer 16 has a thickness t₂. The inner cladding layer is sandwiched between first and second outer cladding layers 18 and 20. Outer cladding layers are formed from a material having a refractive index n₃, where n₃ is less than n₂, and have a thickness designated generally t₃. A heat sink 22 is attached to cladding layer 18, and a similar heat sink 24 is attached to cladding layer 20.

Periphery 16P of the cladding layer may be provided with a convex surface curvature perpendicular to the plane of layer. This curvature together with the circular form of the periphery in the plane of the layer gives the periphery the form of an anamorphic lens. This is convenient for coupling optical pump energy into the cladding layer as described further hereinbelow. In alternate embodiment, the periphery of the cladding layer is planar. In this case, it may be desirable to use diode pump lasers with focusing lenses (see for example, U.S. Pat. No. 5,949,932, incorporated herein by reference).

Spiral waveguide 14 has an inner terminal end 14A having a highly reflective cap, preferably a Bragg grating reflector 26. An output beam coupling notch 28 in the periphery of the cladding layer is disposed on an outer terminal end 14B of waveguide 14 and provides an output route for an output beam as indicated in FIG. 1A.

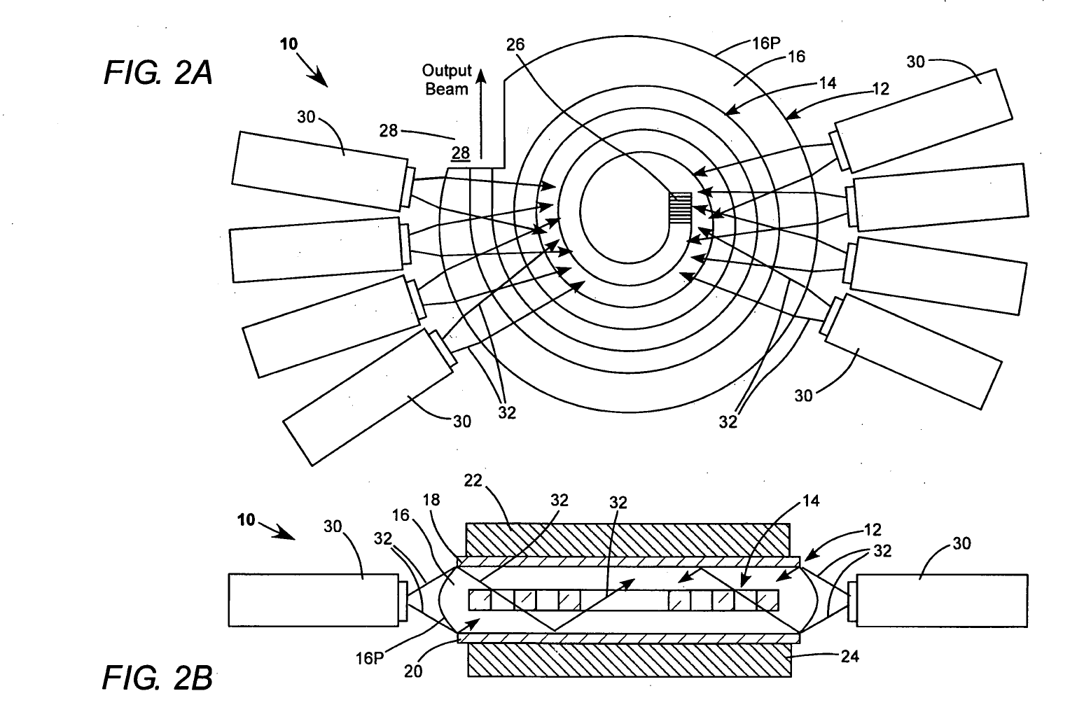

Referring now to FIGS. 2A and 2B, in one preferred arrangement for delivering optical pump energy to spiral waveguide 14 a plurality of semiconductor diode pump lasers 30 are arrayed outside periphery 16P of the wafer body at the level of the inner cladding layer 16. The diode pump lasers provide excitation energy designated by rays 32. The excitation energy is free-space coupled through the edge of the wafer body 12, i.e., through periphery 16P of inner cladding layer 16, and into the inner cladding layer. The pump energy is confined between the outer cladding layers and, due to multiple reflections between the outer cladding layers, activates ions in the ion-doped spiral waveguide 14 to stimulate a laser light emission along the longitudinal axis of the waveguide (not shown). Accordingly, as with prior art DC devices, the apparatus converts the low brightness energy from the discrete pump diode lasers in the array to a higher brightness output radiation. The wavelength of the output radiation is dependent on the characteristics of the ions in the waveguide material, the pump laser wavelength λₚᵤₘₚ, and the optical path length of the fiber laser cavity, i.e., of waveguide 14.

The following relationships are important for the design of a laser in accordance with the present invention. Refractive indices of the cladding follow a relationship n₁>n₂>n₃. This provides for efficient waveguiding of laser radiation in waveguide 14 and pump energy in cladding layer 16. Regarding dimensions of waveguide 14, t₁ is preferably on the order of w₁ and t₁ is equal to w₁, for a square cross-section waveguide. The values of n₁, t₁, and w₁ are determined by the desired transverse mode structure and polarization state of the output laser beam. Spacing Λ₁ between spirals is greater than w₁, and is chosen to be large enough to avoid evanescent wave coupling between spirals. Regarding thickness of the cladding layers, t₂ should be greater than twice t₁ and preferably much greater than twice t₁ for practical wafer fabrication. Thickness t₃ of outer cladding layers 18 and 20 is greater than λₚᵤₘₚ, and is chosen to avoid evanescent wave coupling of pump laser energy into heat sinks 22 and 24. Diameter D of disk body 12, is chosen to be large enough to accommodate the desired number of spirals of waveguide 14, i.e., the desired laser cavity length and gain, and large enough to avoid bending losses in the inner most spirals.

Other relationships obtain that are consistent with previously published laser physics and laser engineering principles. See for example: O. Svelto and D. C. Hanna, Principles of Lasers, (Plenum Press, NY, 1989); M. J. Weber, CRC Handbook of Laser Science and Technology, Vol. III, (CRC Press, Boca Raton, Fla., 1986); and S. Sudo, Optical Fiber Amplifiers, (Artech House, Norwood, Mass., 1997), all of which are incorporated in their entirety by reference herein.

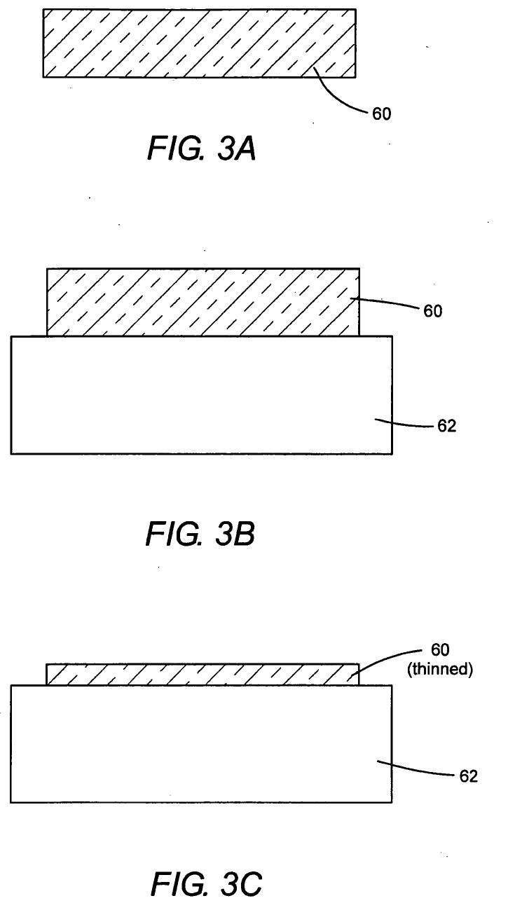

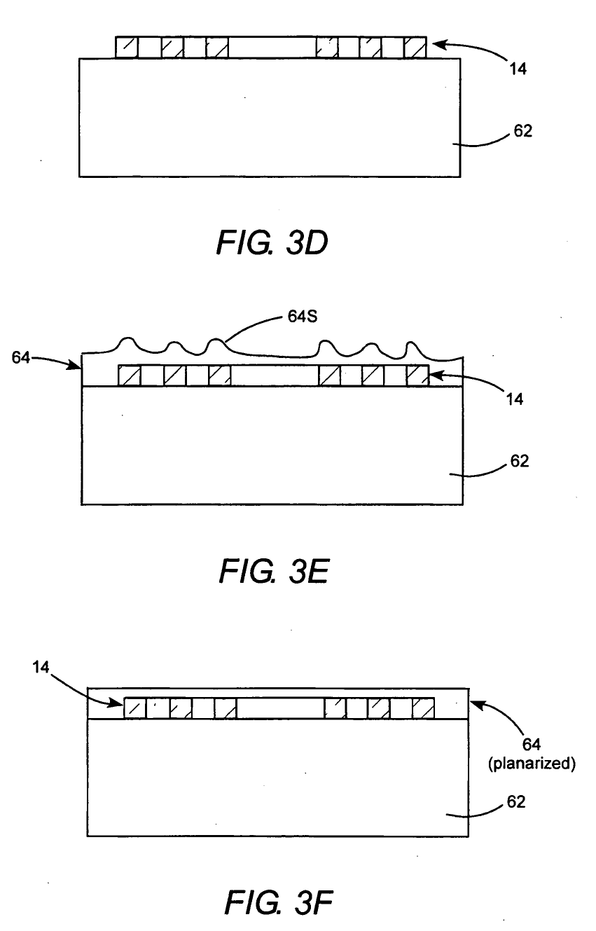

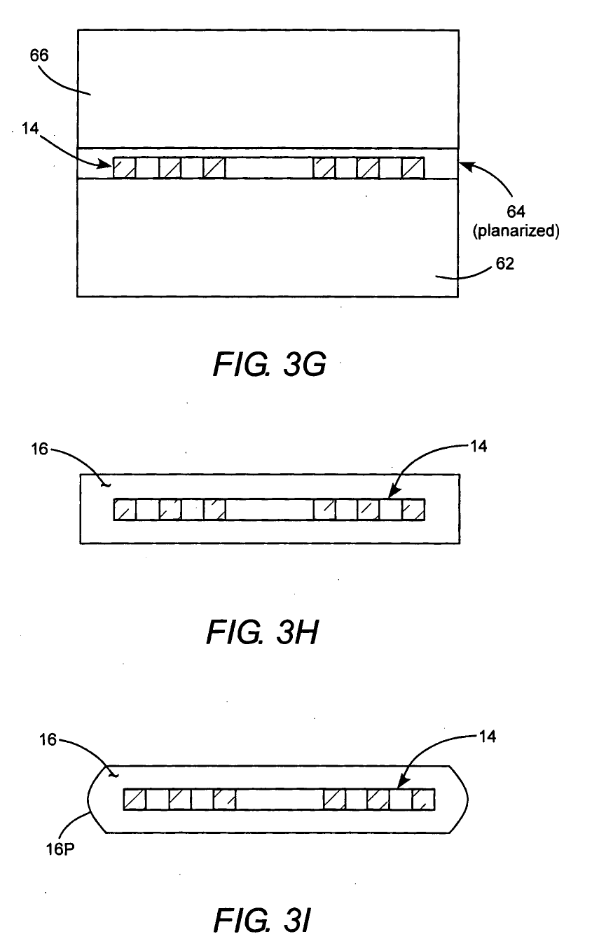

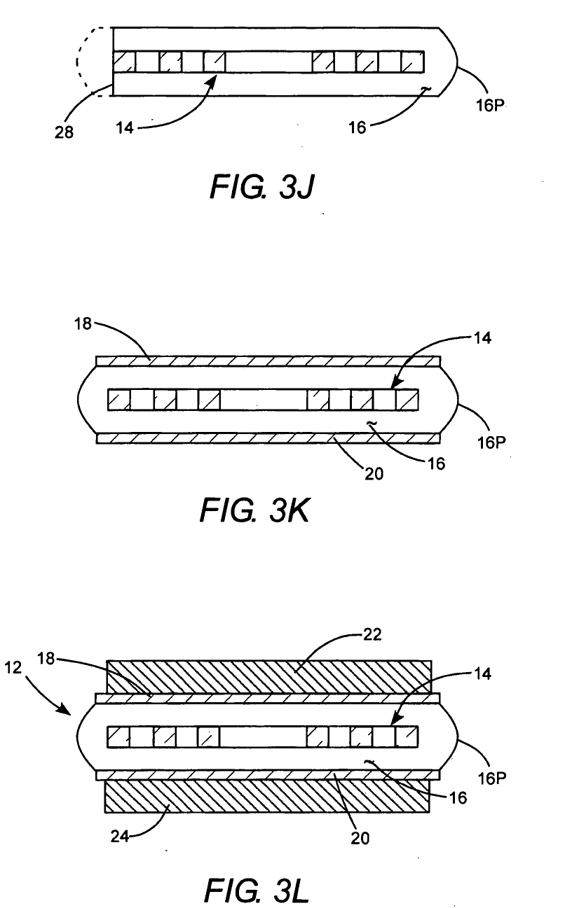

FIGS. 3A-L schematically illustrate steps, in seriatim, in one preferred method of fabricating disc body 12 of above-described laser 10. In a first step (see FIG. 3A) a glass wafer 60 doped with a rare earth element is provided, the ion-doped wafer having a refractive index (n₁). The wafer provides the material from which spiral waveguide 14 will be made.

In a second step (see FIG. 3B) doped glass wafer 60 is bonded to a glass block 64 having a diameter D. The bonding is effected either by optical contact or diffusion bonding. The glass of the block has a refractive index (n₂) and will provide a part of inner cladding layer 16.

Next, wafer 60 is ground and polished to a thickness t₁ (see FIG. 3C). This is the thickness of the spiral waveguide 14.

In a fourth step, the waveguide layer is patterned and etched (or micro-machined) into the spiral configuration of waveguide 14 (see FIG. 3D). Waveguide 14 provides the laser cavity as discussed above. The area from which the material was removed to create the spiral waveguide defines a spiral spacer channel.

Next, a capping layer 64 having a refractive index as closely matched to n₂ as practicable is deposited onto spiral waveguide 14 (see FIG. 3E). The deposited capping layer has an uneven surface 64S.

Next, surface 64S of capping layer 64 is planarized (see FIG. 3F) and Bragg reflector 26 is written on the inner terminal end of the waveguide spiral. Procedures for writing a Bragg grating in a waveguide are well-known in the art and accordingly are not described or illustrated herein.

Following the planarizing and grating writing steps, a glass superstrate 66 is contact or diffusion bonded to planarized capping layer 64 (see FIG. 3G). The superstrate has a refractive index matched to n₂. With the superstrate in place, physical elements for providing the inner cladding layer 16 are present.

Next, substrate 62 and superstrate 66 are ground and polished to a total thickness t₂ (see FIG. 3H). This thickness is distributed around waveguide 14 as required to provide inner cladding layer 16 in which the waveguide is immersed. If desired, (see FIG. 31) the periphery 16P of inner cladding layer 16 can be ground and polished to provide a convex surface suitable for focusing the excitation energy from the semiconductor diode pump lasers into the inner cladding layer. Following that polishing step, output beam coupling notch 28 is cut, ground, and polished on the perimeter 16P of the inner cladding (see FIG. 3J). The outer cladding layers 18 and 20 are then deposited on opposite sides of inner cladding layer 16 (see FIG. 3K). After these outer cladding layers are deposited the heat sinks are attached to the outer cladding layers to complete the disc body 12. The complete laser can then be completed by adding pump diode lasers as depicted in FIGS. 2A and 2B.

The invention can be fabricated using planar processing techniques that are widely used in the production of integrated circuits, opto-electronic semiconductor devices, and optical components, for example, thin-film deposition, photolithographic patterning, etching, contact bonding, and polishing. The resulting monolithic wafer structure preserves all of the good features of fiber laser technology such as compactness, high optical conversion efficiency, and excellent output beam quality. The invention allows for very effective heat sinking through both flat large area wafer surfaces and, including the pump lasers around the wafer perimeter, it consists of fewer piece parts than current fiber lasers. Therefore, the invention is intrinsically more reliable and less expensive to manufacture than the existing fiber lasers and other solid state lasers.

The present invention eliminates the need to handle discrete fiber in the formation of the ion-doped waveguide laser cavity, eliminates the need for a fiber binding matrix (to suppress damage due to mechanical vibration), and eliminates the need for any pump laser fiber coupling (and all associated fiber splices). The invention integrates a self-aligned anamorphic lensing function at the edge of the wafer to efficiently couple pump laser energy from single emitter pumps or from multiple emitter bar pumps into the laser cavity. The monolithic nature of the invention lends itself to the cost-saving benefits of wafer scale planar processing techniques.

Applications and possible uses of the invention are manifold. For example, the present invention could be employed to provide fiber delivered IR laser energy for material processing, such as laser engraving, micro-bending, soldering, heat treating, drilling, cutting, welding, and the like. The invention is particularly attractive in the high power domain because it can use relatively inexpensive multiple emitter semiconductor pump laser bars without any discrete free-space or fiber-optic coupling components.

It is contemplated that the present invention be employed to provide fiber delivery of tightly focused IR laser energy onto gas clusters or metal targets to induce plasma generation of soft x-rays. This is one of the most promising approaches to the reliable generation of soft x-rays for next generation high resolution integrated circuit photolithographic patterning.

It is further contemplated that the present invention be employed to provide fiber delivery of frequency upconverted IR laser energy for visible wavelength projection display or high speed reprographic applications. The invention readily lends itself to the integration of suitable upconversion materials, for example, ion-doped fluoride glass, in the wafer structure.

Further, the present invention could be utilized in multiple output single wavelength applications, for example, laser marking and reprographics. Multiple independent laser cavities can be formed within a single ion-doped layer by interleaving spiral waveguides in the layer.

Moreover, the present invention may be employed in multiple wavelength applications, including, for example, red/green/blue wavelengths for projection display. Multiple independent spiral laser cavities can be formed by stacking multiple ion-doped layers within the monolithic wafer structure. Thus, one wafer can be designed to incorporate multiple waveguide lasers emitting at different wavelengths.

Finally, among the many presently contemplated uses, the present invention can be employed in multiple output/multiple wavelength applications for example, color sensitive laser marking and reprographics. Multiple independent laser cavities can be formed within a single ion-doped layer by interleaving spiral waveguides in the layer, and multiple ion-doped layers can be then formed by stacking multiple ion-doped layers within the monolithic wafer structure.

The present invention is described above in terms of a preferred and other embodiments. The invention is not limited, however, to the embodiments described and depicted. Rather, the invention is limited only by the claims appended hereto.

1. A waveguide laser comprising:
a planar support structure formed from a first cladding material;
a rectangular waveguide channel formed within said support structure, said waveguide channel being formed from a doped glass material, said channel having a spiral configuration wound such that the cladding material of the support structure is interleaved between adjacent walls of the waveguide channel, with the radial inner end of said waveguide channel having a reflector and the radial outer end defining an output coupler;
a cladding layer formed on one of the surfaces of the planar support structure and being formed from a second cladding material;
a heat sink mounted on said cladding layer; and
a plurality of optical pump sources aligned with the side edges of the planar support structure for optically exciting the material of the waveguide channel to generate a beam of laser radiation.

2. A waveguide laser as recited in claim 1, wherein the radially outer side wall of the planar support structure is convex in cross section.

3. A waveguide laser as recited in claim 1, wherein the index of refraction of the first cladding material is less than the index of refraction of the doped glass material forming the waveguide channel and greater than the index of refraction of the cladding layer.

4. A waveguide laser as recited in claim 1, wherein the thickness of the cladding layer is greater than the wavelength of the output of the pump source.

5. A waveguide laser comprising:
a planar support structure formed from a first cladding material;
a rectangular waveguide channel formed within said support structure, said waveguide channel being formed from a doped glass material, said channel having a spiral configuration wound such that the cladding material of the support structure is interleaved between adjacent walls of the waveguide channel, with the radial inner end of said waveguide channel having a grating reflector and the radial outer end defining an output coupler;
a pair of cladding layers formed on opposed the surfaces of the planar support structure and being formed from a second cladding material;
a pair of heat sinks mounted on opposed surfaces of said cladding layers; and
a plurality of optical pump sources aligned with the side edges of the planar support structure for optically exciting the material of the waveguide channel to generate a beam of laser radiation.

6. A waveguide laser as recited in claim 5, wherein the radially outer side wall of the planar support structure is convex in cross section.

7. A waveguide laser as recited in claim 5, wherein the index of refraction of the first cladding material is less than the index of refraction of the doped glass material forming the waveguide channel and greater than the index of refraction of the cladding layers.

8. A waveguide laser as recited in claim 5, wherein the thickness of each cladding layer is greater than the wavelength of the output of the pump source.

9. A waveguide laser comprising:
a planar member including an elongated waveguide channel configured in a planar spiral configuration formed by removing material from a solid body of doped material and having a rectangular cross-section, said waveguide channel being immersed in a first cladding member having first and second opposite planar surfaces and an outer sidewall, with the inner end of the spiral waveguide channel including a reflector and with the outer end of the spiral waveguide channel functioning as an output coupler;
a first cladding layer formed on at least one of said planar surfaces of said cladding member;
a heat sink bonded to said first cladding layer; and
a plurality of optical pump sources aligned with the outer sidewall of said cladding member for optically exciting the doped material in the waveguide channel to generate a beam of laser radiation.

10. A waveguide laser as recited in claim 9, wherein the outer side wall of the planar member is convex in cross section.

11. A waveguide laser as recited in claim 9, wherein the index of refraction of the first cladding member is less than the index of refraction of the doped material forming the waveguide channel and greater than the index of refraction of the first cladding layer.

12. A waveguide laser as recited in claim 9, wherein the thickness of the first cladding layer is greater than the wavelength of the output of the pump source.

13. A waveguide laser as recited in claim 9, further including a second cladding layer formed on the other opposed planar surface of said cladding member and further including a second heat sink bonded to said second cladding layer.

14. A waveguide laser comprising:
a planar member including an elongated waveguide channel formed from a doped material, said waveguide channel being configured in a planar spiral configuration with a complementary spacer channel separating adjacent side walls of the waveguide channel, said spacer channel being formed from a cladding material and with the radially inner end of the spiral waveguide channel including a reflector and with the radially outer end of the spiral waveguide channel functioning as an output coupler;
opposed first and second cladding layers formed on the opposed planar surfaces of the planar member;
a third cladding layer formed on one of the said first or second cladding layers;
a heat sink bonded to said third layer; and
a plurality of optical pump sources aligned with the side edges of the planar member for optically exciting the doped material in the waveguide channel to generate a beam of laser radiation.

15. A waveguide laser as recited in claim 14, wherein the radially outer side wall of the planar member is convex in cross section.

16. A waveguide laser as recited in claim 14, wherein the index of refraction of the first and second cladding layers is substantially similar to the index of refraction of the cladding material of the spacer channel and wherein the index of refraction of the first and second cladding layers is less than the index of refraction of the doped material forming the waveguide channel and greater than the index of refraction of the third cladding layer.

17. A waveguide laser as recited in claim 14, wherein the thickness of the third cladding layer is greater than the wavelength of the output of the pump source.

18. A waveguide laser comprising:
a planar member including an elongated waveguide channel formed from a rare earth doped glass and having a rectangular cross section, said waveguide channel being configured in a planar spiral configuration with a complementary spacer channel separating adjacent side walls of the waveguide channel, said spacer channel being formed from a cladding material and with the radially inner end of the spiral waveguide channel including a grating reflector and with the radially outer end of the spiral waveguide channel functioning as an output coupler;
opposed first and second cladding layers formed on the opposed planar surfaces of the planar member;
opposed third and fourth cladding layers formed on opposed surfaces of said first or second cladding layers;
a pair of heat sinks bonded to opposed surfaces of said third and fourth cladding layers; and
a plurality of optical pump sources aligned with the side edges of the planar member for optically exciting the doped material in the waveguide channel to generate a beam of laser radiation.

19. A waveguide laser as recited in claim 18, wherein the radially outer side wall of the planar member is convex in cross section.

20. A waveguide laser as recited in claim 19, wherein the index of refraction of the first and second cladding layers is substantially similar to the index of refraction of the cladding material of the spacer channel and wherein the index of refraction of the first and second cladding layers is less than the index of refraction of the doped glass forming the waveguide channel and greater than the index of refraction of the third and fourth cladding layers.

21. A waveguide laser as recited in claim 14, wherein the thickness of each of the third and fourth cladding layers is greater than the wavelength of the output of the pump source.

22. A method of making a waveguide laser comprising the steps of:
forming a wafer of glass doped with a laser material;
bonding the wafer to a substrate;
removing material from the wafer to define a spiral waveguide channel formed from the doped glass material, with the area from which the material was removed defining a spiral spacer channel between the adjacent walls of the waveguide channel;
depositing a capping layer on top of the waveguide channel and in a manner to fill the spacer channel, with the index of refraction of material forming the capping layer being similar to the index of refraction of the substrate to define a cladding region about said waveguide channel;
forming a reflector at the radially inner end of said spiral waveguide channel;
depositing a second cladding layer on one of said substrate or said cladding region;
bonding a heat sink to the second cladding layer; and
positioning a plurality of optical pump sources aligned with the side edges of the waveguide channel for optically exciting the laser material of the waveguide channel.

23. A waveguide laser made in accordance with claim 22.

24. A method of making a waveguide laser comprising the steps of:
forming a wafer of glass material doped with a laser material;
bonding the wafer to a glass substrate of cladding material;
removing by either machining or etching material from the wafer to define a spiral waveguide channel formed from the doped glass material, said channel having a generally rectangular cross section, with the area from which the material was removed defining a spiral spacer channel between the adjacent walls of the waveguide channel;
depositing a capping layer on top of the waveguide channel and in a manner to fill the spacer channel, with the index of refraction of material forming the capping layer being similar to the index of refraction of the substrate;
forming a grating reflector at the radially inner end of said spiral waveguide channel;
planarizing the capping layer;
depositing a first cladding layer on the capping layer;
depositing a pair of second glass cladding layers on said capping layer and said substrate;
bonding a pair of heat sinks on opposed surfaces of said second cladding layers; and
positioning a plurality of optical pump sources aligned with the side edges of the waveguide channel for optically exciting the laser material of the waveguide channel.

25. A waveguide laser made in accordance with claim 24.

26. A method of making a waveguide laser comprising the steps of:
providing a planar member of a doped glass material;
bonding the planar member of doped glass material to a substrate;
thinning the planar member of doped glass material to form a wafer of the doped glass material on the first substrate;
removing by either machining or etching material from the wafer to define a spiral waveguide channel formed from the doped glass material, said channel having a generally rectangular cross section, with the area from which the material was removed defining a spiral spacer channel between the adjacent walls of the waveguide channel;
depositing a capping layer on top of the waveguide channel and in a manner to fill the spacer channel, with the index of refraction of material forming the capping layer being similar to the index of refraction of the first substrate;
forming a grating reflector at the radially inner end of said spiral waveguide channel;
planarizing the capping layer;
bonding a second substrate to the planarized capping layer, said second substrate having an index of refraction similar to the refractive index of said fist substrate and said capping material;
thinning said first and second substrates to define a cladding region about said waveguide channel;
depositing a pair of cladding layers on opposed surfaces of said cladding region;
bonding a pair of heat sinks on opposed surfaces of said cladding layers; and
positioning a plurality of optical pump sources aligned with side edges of the cladding region for optically exciting the laser material of the waveguide channel.

27. A waveguide laser made in accordance with claim 26.
